(19) United States
(12) Patent Application Publication
(10) Pub. No.: US 2014/0324970 A1
(43) Pub. Date: Oct. 30, 2014

(54) METHOD AND SYSTEM FOR INTELLIGENTLY NETWORKED COMMUNITIES

(71) Applicant: Michael Vahigh Peshkam, Diamond Bar, CA (US)

(72) Inventor: Michael Vahigh Peshkam, Diamond Bar, CA (US)

(73) Assignee: I AM, INC., Diamond Bar, CA (US)

(21) Appl. No.: 14/124,022

(22) PCT Filed: May 19, 2012
(86) PCT No.: PCT/US12/38740

§ 371 Date: Jan. 31, 2014

Related U.S. Application Data
(60) Provisional application No. 61/493,869, filed on Jun. 6, 2011.
(60) Provisional application No. 61/536,223, filed on Sep. 19, 2011.
(60) Provisional application No. 61/609,552, filed on Mar. 12, 2012.

(51) Int. Cl. H04L 29/06

(52) U.S. Cl. CPC H04L 65/403
USPC 709/204

(57) ABSTRACT

A method, system and computer program product for providing intelligently networked communities, including at least one of identifying and selecting suitable potential opportunities for a user; pushing know-how to a user for actualizing an opportunity, including setting targets to achieve a goal; connecting and teaming up a user with other users that complement capabilities and capacities of the user in pursuit of a goal; and generating a goal map for a user to help the user to make decisions and adjust a course when encountering problems along a journey to a goal.

### CROSS REFERENCE TO RELATED DOCUMENTS

The present invention is related to U.S. Provisional Patent Application Ser. No. 61/609,552 of Peshkam, entitled “METHOD AND SYSTEM FOR INTELLIGENTLY NETWORKED COMMUNITIES,” filed on Mar. 12, 2012, U.S. Provisional Patent Application Ser. No. 61/536,223 of Peshkam, entitled “METHOD AND SYSTEM FOR INTELLIGENTLY NETWORKED COMMUNITIES,” filed on Sep. 19, 2011, and U.S. Provisional Patent Application Ser. No. 61/493,869 of Peshkam, entitled “METHOD AND SYSTEM FOR INTELLIGENTLY NETWORKED COMMUNITIES,” filed on Jun. 6, 2011, the entire disclosures of all of which are hereby incorporated by reference herein.

### BACKGROUND OF THE INVENTION

1. Field of the Invention

The present disclosure generally relates to social networking systems and methods, and more particularly to a novel approach, for individuals and organizations, hereinafter referred to as “users”, to achieve and grow, including methods and systems for finding, creating, and receiving relevant knowledge, experience, know-how and opportunities, as well as allowing connecting with other users in order to pursue, achieve and set goals, and actualize opportunities.

2. Discussion of the Background

The drive for achievement is a basic human need. Coupled with this is a constant expectation to be more competitive, innovative, and productive. Meeting this need and expectation is increasingly becoming more difficult in the complex, globalized, and interconnected world of today. Recent social media related systems and methods have helped with the noted issues to some extent. However, the current social media related systems and methods impact users in a major way, wasting precious time. Therefore there still is a need for improved social media related systems and methods.

### SUMMARY OF THE INVENTION

The above and other problems with respect to social media related systems and methods are addressed by the illustrative embodiments of the present disclosure which provide an improved social networking system and method. Accordingly, the present disclosure provides an environment with customizable tools that accounts for and honors users' individuality, and integrates their intellectual capital, connections and communities. The systems and methods allow users to create, process, and enhance their own knowledge promoting collaborative mentoring towards optimal decision making and achieving goals. The systems and methods also help users to know themselves better, live more consciously, and contribute more richly. In addition, the systems and methods provide powerful forms of collaboration, and knowledge sharing to increase innovation, productivity, and growth of users. The pursuit of opportunities, common goals and interests from both these groups leads to the formation of the expert networks and thus the Intelligently Networked Communities (INCs).

Accordingly, in illustrative aspects, there are provided methods, systems and computer program products for providing intelligently networked communities, including at least one of identifying and selecting suitable potential opportunities for a user; pushing know-how to a user for actualizing an opportunity, including setting targets to achieve a goal; connecting and teaming up a user with other users that complement capabilities and capacities of the user in pursuit of a goal; and generating a goal map for a user to help the user to make decisions and adjust a course when encountering problems along a journey to a goal.

The information gathered and received from a plurality of users is provided and made available to other users.

The illustrative methods, systems and computer program products can further include establishing connections among users who seek and pursue common goals, irrespective of geographical boundaries, social status, and contacts within a personal network in real life.

The illustrative methods, systems and computer program products can further include pushing goal specific know-how that tailored for a user to a user, including steps that a user can take and relevant knowledge and experience available to a user to achieve a particular set goal.

The goal specific know-how is tailored and pushed to a user, based on recorded knowledge of a user from a past experience of achieving other goals and comparing complimentarity of a user to a plurality of other users.

The building blocks can be used for creating modular, context-specific, multimedia enriched, content.

The building blocks can include subject-specific, multimedia content for a user to create, promote, and/or offer expertise of the user.

The building blocks can be created using system tools and techniques available to a user to describe a particular expertise and/or know-how related to specific subjects.

The illustrative methods, systems and computer program products can further include customizing of a goal map for a specific goal that a user pursues, including customizations performed on past experience and knowledge of a user and plurality of other users in pursuing a similar goal.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present disclosure are illustrated by way of example, and not by way of limitation, in the figures of the accompanying drawings and in which like reference numerals refer to similar elements and in which:

FIG. 1 is an illustrative diagram which depicts pushing tailored know-how, other users, and a goal map to a user, wherein the user receives relevant data rather than wasting time looking for data, and the data is tailored to the user;

FIG. 2 is an illustrative diagram which depicts collective intelligence, and how users can be connected without the need to know each other;

FIG. 3 is an illustrative diagram depicting an opportunities/goal network, wherein common goals and opportunities are clustered and connected with each other;

FIG. 4 is an illustrative diagram which depicts users and their goals and opportunities, wherein users connected in current conventional social networking sites are shown versus Intelligently Networked Communities (INC) of the present disclosure;

FIG. 5 is an illustrative diagram depicting the Intelligently Networked Communities (INCs) at a macro level;

FIGS. 6-7 are illustrative flow charts of how collective intelligence is created by users, tailored and pushed to each user, enabling users to pursue new opportunities and achieve goals;

FIG. 8 is an illustrative diagram which depicts how the present disclosure combines individual users intelligence, referred to as “crowd intelligence,” and the enterprise users intelligence, referred to as “business intelligence,” to create a combined collective intelligence, referred to as “super intelligence;”

FIG. 9 is an illustrative system diagram for enabling the methods and systems of FIGS. 1-8;

FIG. 10 illustrates an exemplary process model including communities and building blocks that can be based on the embodiments of FIGS. 1-9;

FIG. 11 illustrates an exemplary process model including further details of communities and building blocks that can be based on the embodiments of FIGS. 1-10;

FIG. 12 illustrates an exemplary process model including further details of communities and building blocks that can be based on the embodiments of FIGS. 1-11;

FIG. 13 illustrates an exemplary process model including a common marketplace that can be based on the embodiments of FIGS. 1-12; and

FIG. 14 illustrates an exemplary process model including common, dedicated and private marketplaces that can be based on the embodiments of FIGS. 1-13.

### DETAILED DESCRIPTION OF THE PREFERRED EMBODIMENTS

The present disclosure recognizes the problem that traditionally, every year, over 90% of Americans fail at achieving the goals they set for themselves at the New Year. Possible reasons for this include: (1) Not having the required knowledge and experience to achieve specific goals and reach the set targets (How to?); (2) Not having the right contacts in their network that are experienced in a particular area (With who?); (3) Not knowing the best course of action to take when things go wrong (What to do?); (4) The current online social media in general and the popular social networking websites in particular, while offer librating possibilities, have many limiting practical realities. Accordingly, problems discovered with respect to social networking websites can include:

Failing to identify the right opportunities, which closely match users' capabilities and/or capacities. In the current social media, users may request and be permitted to join various interest groups hoping such a group might lead to opportunities they can pursue. More often than not, membership of such groups does not lead to potential opportunities. That leaves users to use a “shotgun” theory of thinking, wherein users think that by joining more interest groups they may maximize their chances of identifying potential opportunities.

Failing to identify the right know-how in order to pursue an opportunity. The current social networking sites do not offer know-how to users when in pursuit of potential opportunities. Users, to a large measure, are on their own to search the Internet and find relevant know-how

Failing to connect users with other users who are a close match and complementary to their behavioral patterns and biases. Closely matching users may include matching users who are either in pursuit of similar opportunities or willing to mentor/partner/collaborate/team up with or in general assist the user to actualize potential opportunities and achieve the set goal.

Failing to provide the right “goal map” that directs users to the set target in a given time that is realistic for and obtainable by a particular user in order to achieve a goal.

The above-noted and other problems of the current social media impacts users in a major way, as this wastes precious time. Because, users are left on their own, they spend a lot of time, often in vain, looking for the right opportunities, know-how, other users, and a “goal map.” This is time that could have been spent on creativity, productivity, and even quality time with friends and family.

Therefore, there is a need for a method and system to find the right opportunities for users irrespective of their geographical boundaries and position in society, connect the right users that are complementary to each other, provide the right know-how to embark on the journey to actualize the opportunity, and generate the right map to set and achieve goals.

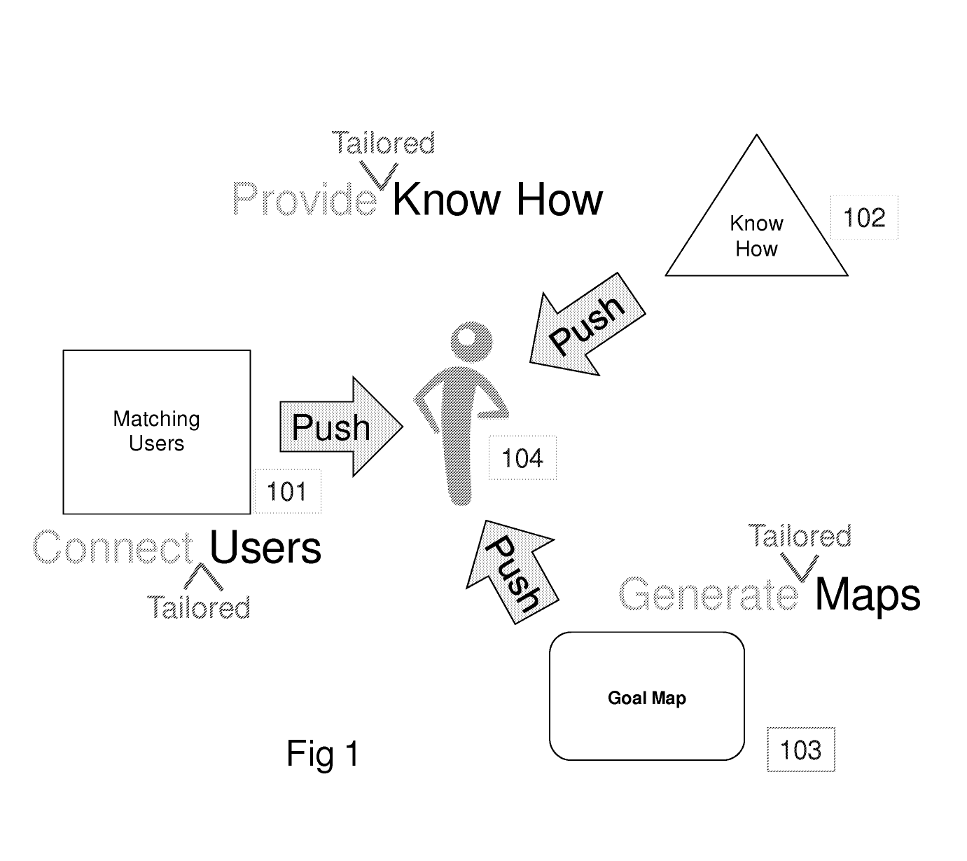

Referring now to the drawings, wherein like reference numerals designate identical or corresponding parts throughout the several views, and more particularly to FIG. 1 thereof, there is illustrated depiction of pushing tailored know-how, matching complementary users, and goal map to the user in pursuit of an opportunity to achieve goals according to an exemplary embodiment. In FIG. 1, the user in pursuit of a goal is shown as 104 at the center. The illustrative system connects other users to user 104, provides know-how 102, and generates a goal map 103, then tailors the know-how 102, the goal map 103, and the users 104, which then are pushed to the user 104. The user 104 also has the choice of searching for additional data within the system. Accordingly, all suitable data employed by the user 104 can be provided. Advantageously, the time saved in acquiring the goal relevant data can be used for a providing more creative and innovative way of achieving the goal faster ofr the user 104.

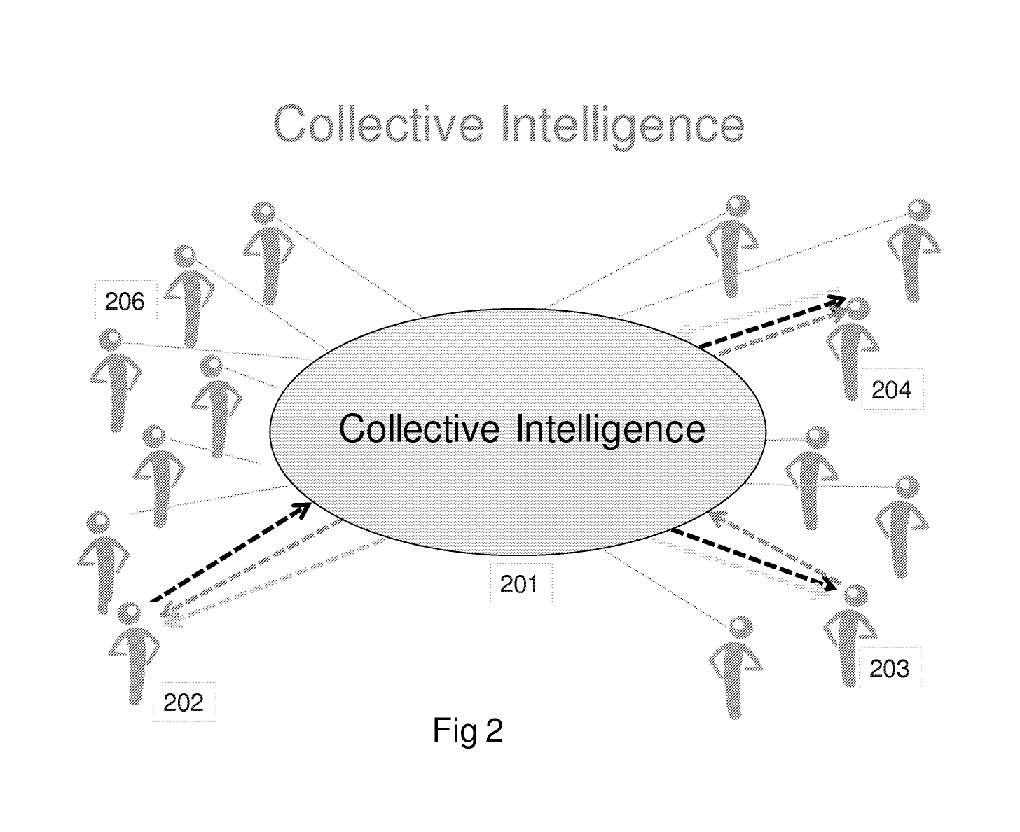

The users in the illustrative system feed their knowledge and experience from the pursuit of a goal into the system, thus creating collective intelligence 201, depicted in FIG. 2. Users for example illustrated as Tom 202, Dick 203, and Harry 205 benefit from their collective knowledge and experience without knowing each other. They continually contribute to the collective intelligence of the system and that in turn benefits all of the users of the system depicted as 206. In addition to the continual expansion of the collective intelligence by the user community, the user and their team of users can be employ other technologies to input additional intelligence generated by experts in particular fields.

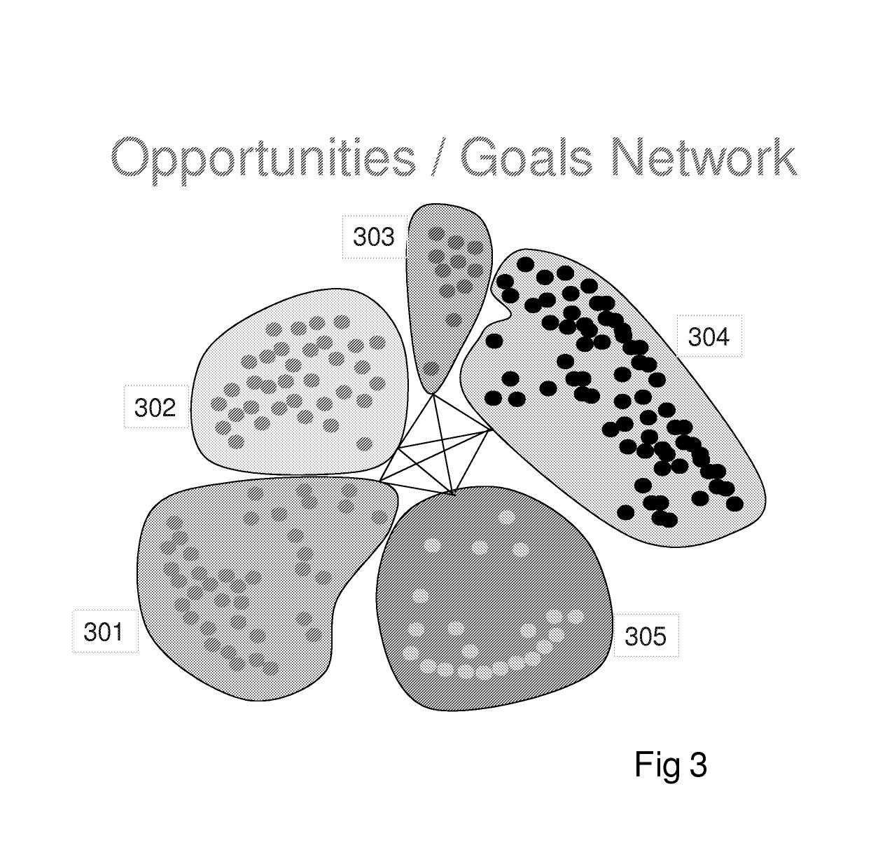

The collective intelligence depicted in FIG. 2 as 201 provides the know-how shown in FIG. 1 as 102. While users benefit from each other's knowledge and experience, they may need to connect, work, and help each other to pursue and achieve the goal together. That is achieved by creating opportunities and goals network illustrated in FIG. 3.

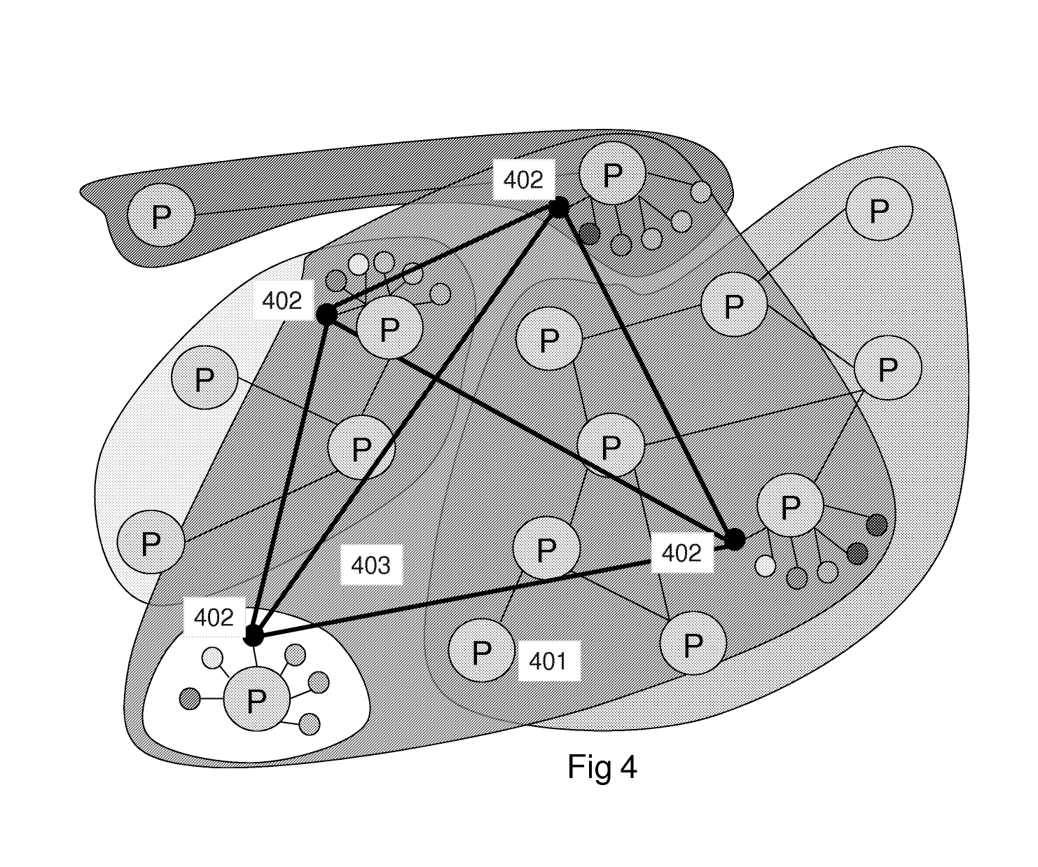

In FIG. 3, users pursuing common goals and opportunities form clusters of such networks 301-305, referred to as Intelligently Networked Communities (INC). Each cluster or INC is depicted by the numerals 301, 302, 303, 304, and 305, as an example. This is further illustrated in FIG. 4 depicting formation of the INCs by the users.

In FIG. 4, users are depicted as the larger circle with the letter P, also depicted as 401. In the current conventional social networking, users connect to each other either by virtue of knowing the other person or being introduced by one, or joining an interest group that may or may not lead to a connection. By contrast, the present disclosure connects users by their goals and opportunities 402, advantageously enabling users to connect with each other and pursue mutually beneficial outcomes and thus form the Intelligently Networked Communities (INC) 403.

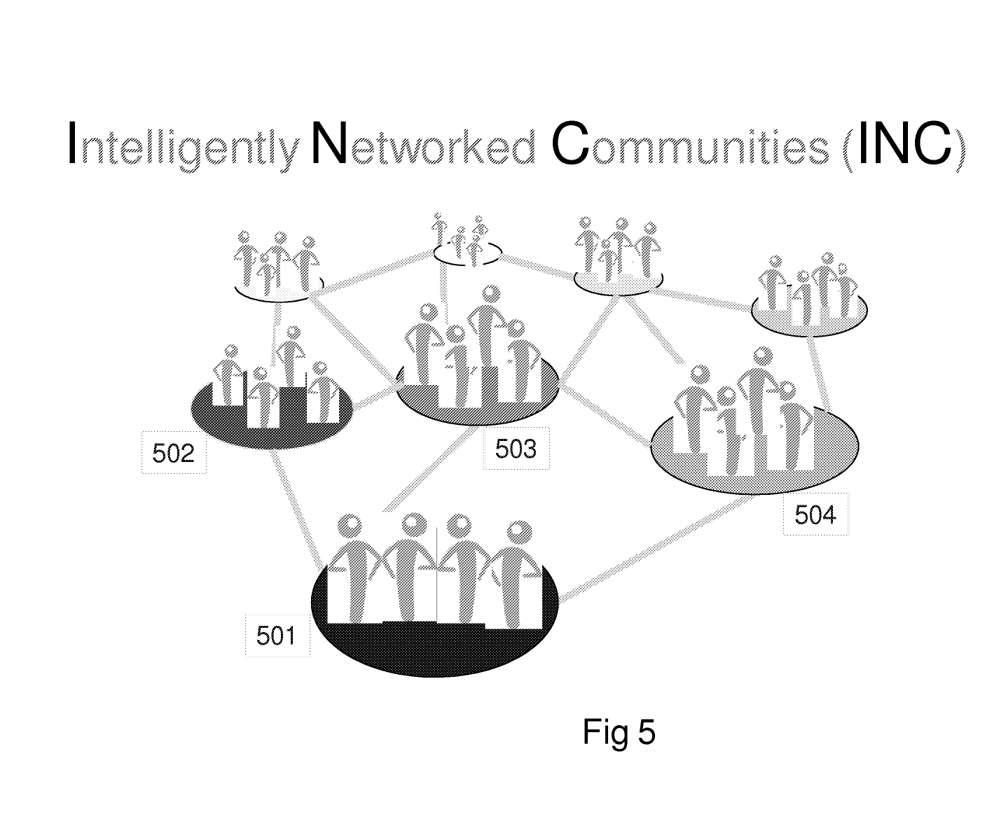

This is further illustrated in FIG. 5, which depicts users clustered around common goals and forming goal specific INCs 501, 502, 503, and 504. In FIG. 5, the resulting effort from pursuit and achievement of goals are recorded in the system by for the users.

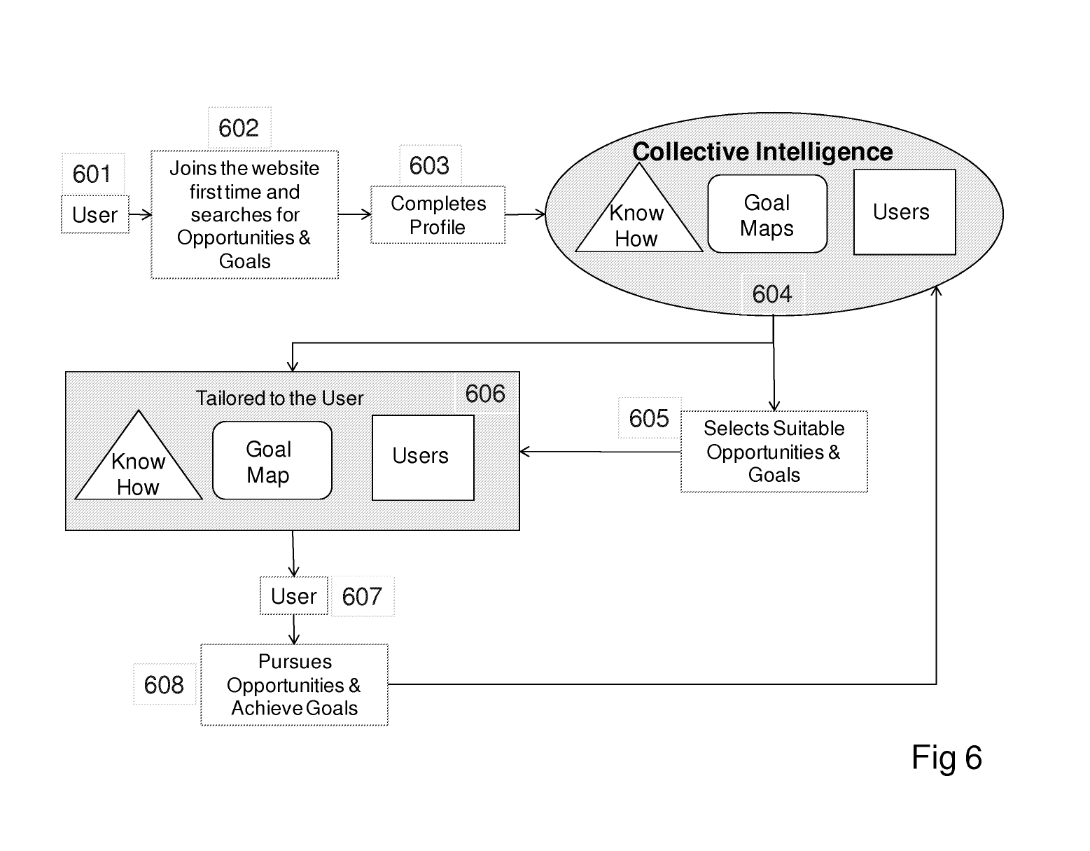

FIG. 6 is a high level flow diagram illustrating how the process works for a user who signs up and joins a website, according to the present systems and methods, for the first time. In FIG. 6, a user 601 joins the website for the first time and searches the system with the view to find and pursue suitable opportunities and goals 602. Upon completing a profile 603, the user 601 begins to receive potential opportunities and goals from the collective intelligence 604. Upon selecting a suitable opportunity or goal 605, the system 604 pushes goal specific know-how, goal map, and complementary users tailored to the user at step 606. Advantageously, the user 601 at step 607 can focus on pursuing the opportunity and achieving the set goal targets 608. The effort from pursuit of the goal is recorded by the system, which adds to the collective intelligence 604.

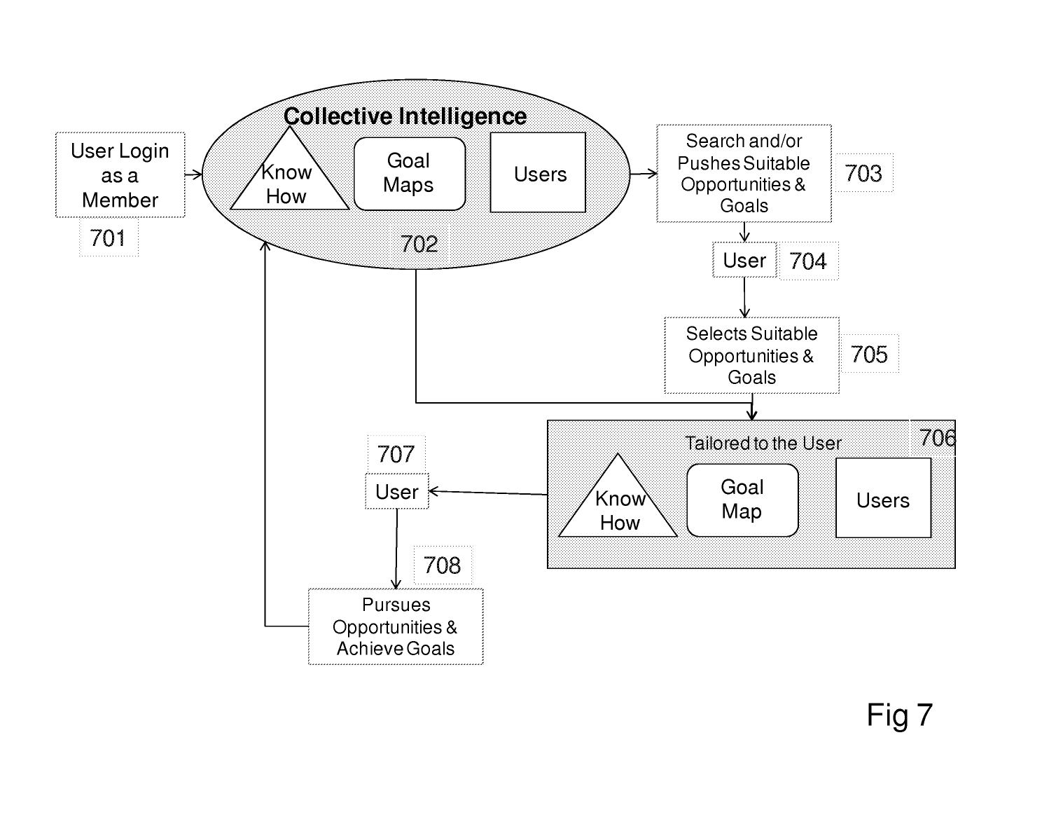

The process for achieving goals by users who are already a member is illustrated in FIG. 7. In FIG. 7, when user logs in to the website at step 701, potential opportunities and goals that can be pursued by the user are pushed by the system's collective intelligence 702 to the user's home page at step 703. The user also can search for other opportunities and goals at step 703. Once user at step 704 selects the goal or the opportunity to pursue, the system at step 702 pushes goal specific know-how, goal map, and complementary users tailored to the user at step 706. Advantageously, the user at step 707 can focus on pursuing the opportunity and achieving the set goal targets 708. The effort from pursuit of the goal is recorded by the system, which adds to the collective intelligence 702.

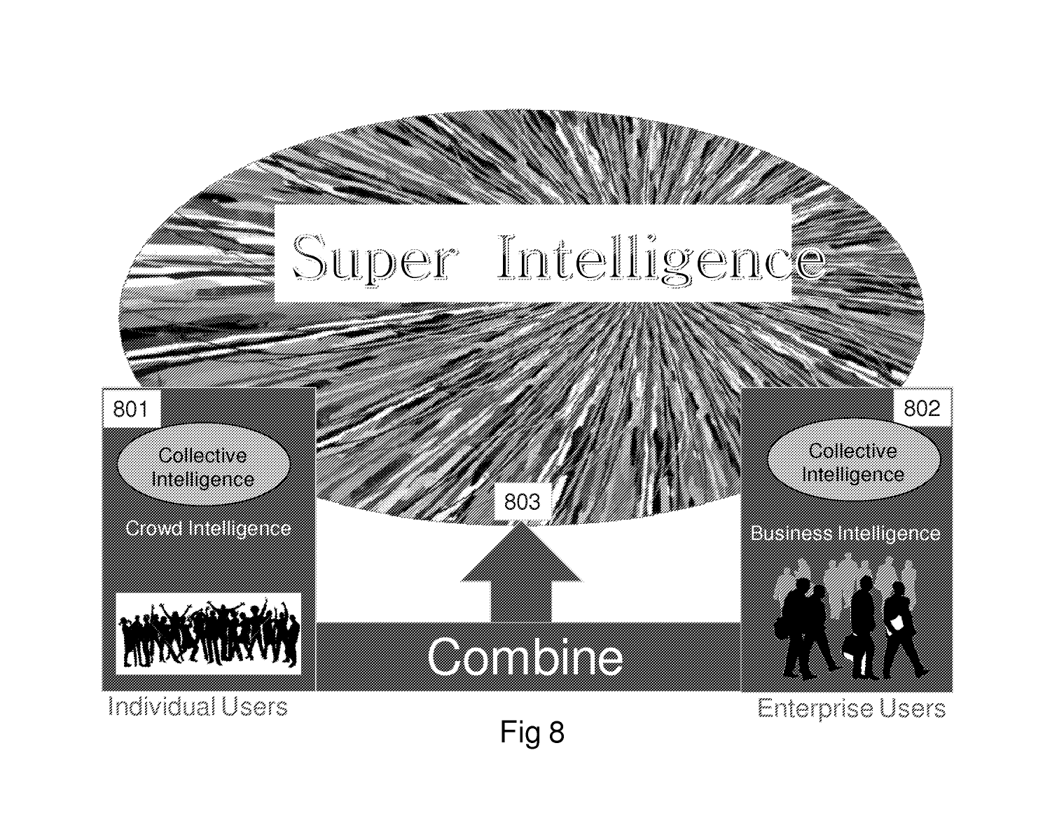

A similar process as that of FIGS. 6 and 7 can be applied to enterprises and organizations. As shown in FIG. 8, the difference is that the enterprise users search for enterprise specific goals and opportunities and the collective intelligence recorded by the system is commonly known as business intelligence 802, as opposed to crowd intelligence 801 that comes from the individuals' users. These two intelligences 801 and 802 can be combined by the present disclosure and create what is referred to herein as super intelligence 803.

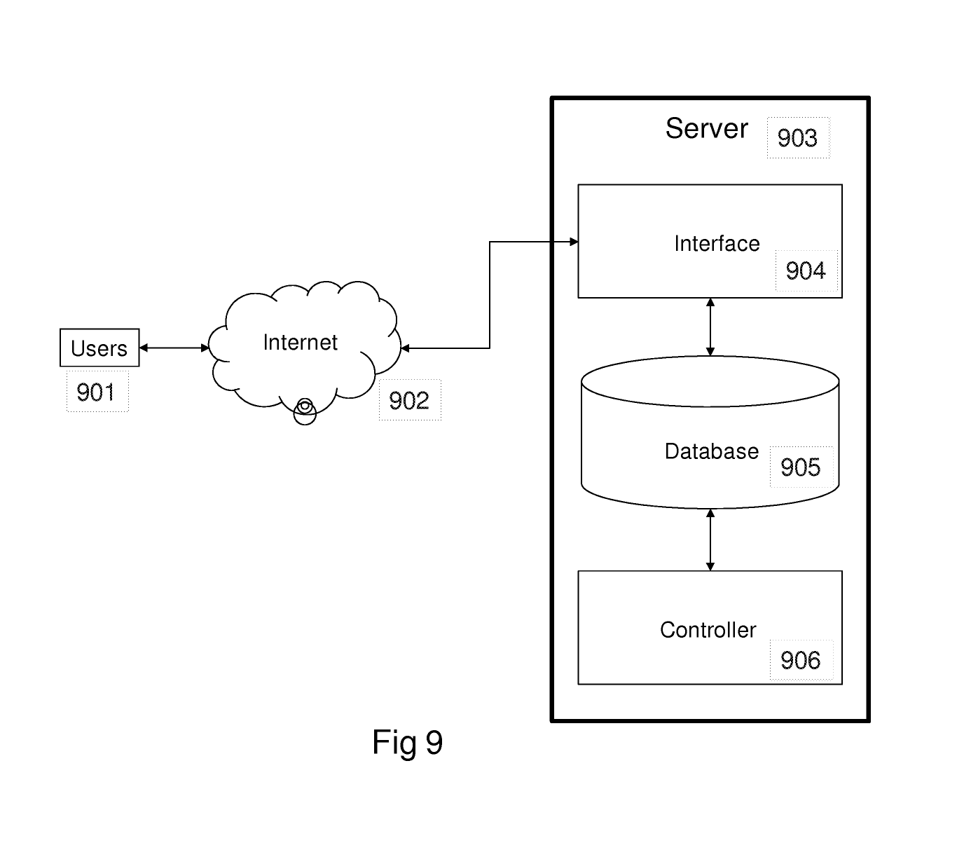

As shown in the illustrative system of FIG. 9, users 901 access a server 903 configured according to the present disclosure by communicating through a communications network 902 (e.g., Internet, cloud network, etc.). A suitable interface 904 allows users to login to the server 903, which can include a database 905 with collective intelligence data and configuration information of INCs residing therein. A controller 906, through various suitable algorithms, and the like, based on the teachings of the present disclosure, processes the data and pushes the processed data to the users, as described hereinbefore.

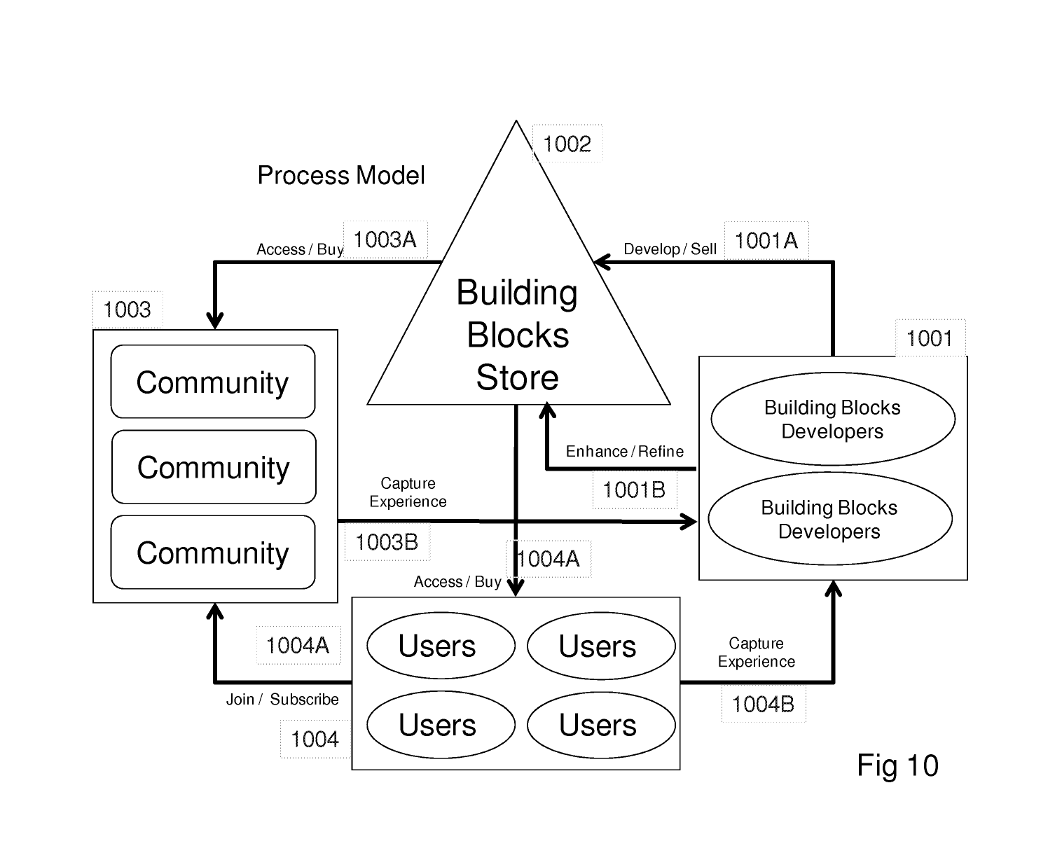

FIG. 10 illustrates an exemplary process model including communities and building blocks that can be based on the embodiments of FIGS. 1-9. In FIG. 10, an analogy to better describe the present systems and methods is visualizing them like a virtual shopping mall. The mall's shops are communities 1003 that can be organized as portals of knowledge on a topic. The merchandise is building blocks (BBs) 1001 composed of specific know-how (e.g., best-practices, common errors, videos, and other sources of knowledge, etc) tailored for a particular objective and goal. Shoppers are essentially users 1004.

Referring to FIG. 10, community owners (COs), like shop owners, set up communities 1003 comprised of various BBs 1001 to cater for users' specific objectives. The COs who set up communities have access to and can buy the BBs 1003A from the store 1002 or create them themselves. The BB 1001 developers create and post them as shown in 1001A at the store 1002 for a price or free as they may choose (e.g., like iPhone apps on iTunes store). The users 1004 employ the systems and methods in order to pursue and reach a particular objective(s)/goal(s). The users 1004 search, identify, and join the most suitable communities 1003 that they think can meet their needs. The users 1004 can have the option, for example, to remain a community member for free with standard privileges, choose to pay subscription fee, determined by the CO and enjoy premium membership benefits, and the like. The users 1004 can also have the option to search and identify BBs 1001 and buy them as shown at 1004A directly from the store 1002 without joining a community 1003.

The BBs 1001 play a central role and provide various advantages, for example, including: (A) BBs 1001 are modular, like Lego building block pieces; (B) BBs 1001 are independent but at the same time can be interlinked to each other; (C) the same BB 1001 can be utilized in many communities 1003 concurrently; (D) BBs 1001 connect the communities 1003 and the users 1004 together creating a huge network of loosely interconnected web of BBs 1001, communities 1003, and users 1004 creating a dynamic interaction among members of different communities 1003 enabling them to share, collaborate, socialize, innovate, produce, learn, co-create together, and the like; (F) the collective assembled BBs 1001 create the structure of a community 1003 (e.g., like a final object designed by Lego pieces); (G) changes and enhancements made to a BB 1001 by members of one community as shown in 1003B and users 1004 who have independently purchased BBs as shown in 1004B benefit, for example, with everyone in all the communities 1003 using the same BB 1001; (H) users 1004 who contribute to enhancement of the BBs 1001 can develop their personal brands and be recognized as subject-matter experts, wherein subsequent developments, refinements, and enhancements of the BBs 1001 lead to the creation of collective intelligence (CI) that can serve all of the communities 1003 and including the worldwide web (WWW); and (I) the collective intelligence (CI) will provide users with personalized data: tailored know-how, matched contacts, suitable opportunities for growth and much more.

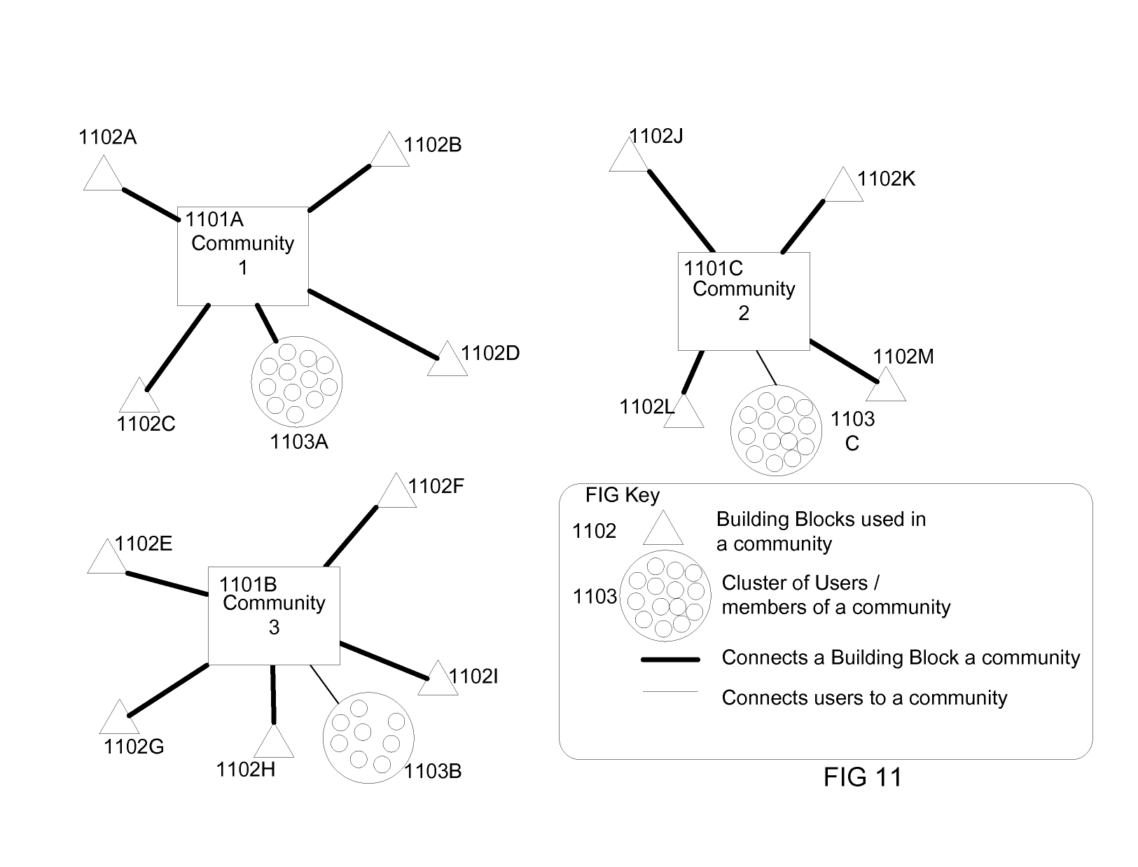

FIG. 11 illustrates an exemplary process model including further details of communities and building blocks that can be based on the embodiments of FIGS. 1-10. In FIG. 11, the shopping mall analogy is expanded further in greater details to illustrate the depth and breadth of the application. The mall's shops depicted as communities 1003 in FIG. 10, in addition to being organized as portals of knowledge on a topic can also be specialized centers of business. These communities created by the community owners (COs) can be for the purpose of either running, managing, conducting etc the entire functions of the business or a number of specific functions of the business in order to reach the COs business, personal, professional, social, organizations objectives and goals. COs can create and own as many communities, also referred to as centers/businesses/hubs and so on as they want to run the affairs of their business both internally and externally. For example, the internal functions of a specific business may encompass departments such as HR, Finance, Engineering, Marketing and more. Likewise, the external functions of a specific business may comprise customer support, sale, advertising, supply chain and more. Thus, COs can create one community for sales, one dedicated to each client, one for each department in the organization, one as a communications platform with their staff, employees, partners, suppliers, and so on.

These communities/business centers can be independent or linked. Independent communities depicted in FIG. 11 each may have their own set of users 1103 and building blocks 1102. The lines connecting the building blocks to a community 1101 show the building blocks are being used only by that community and the users of that community.

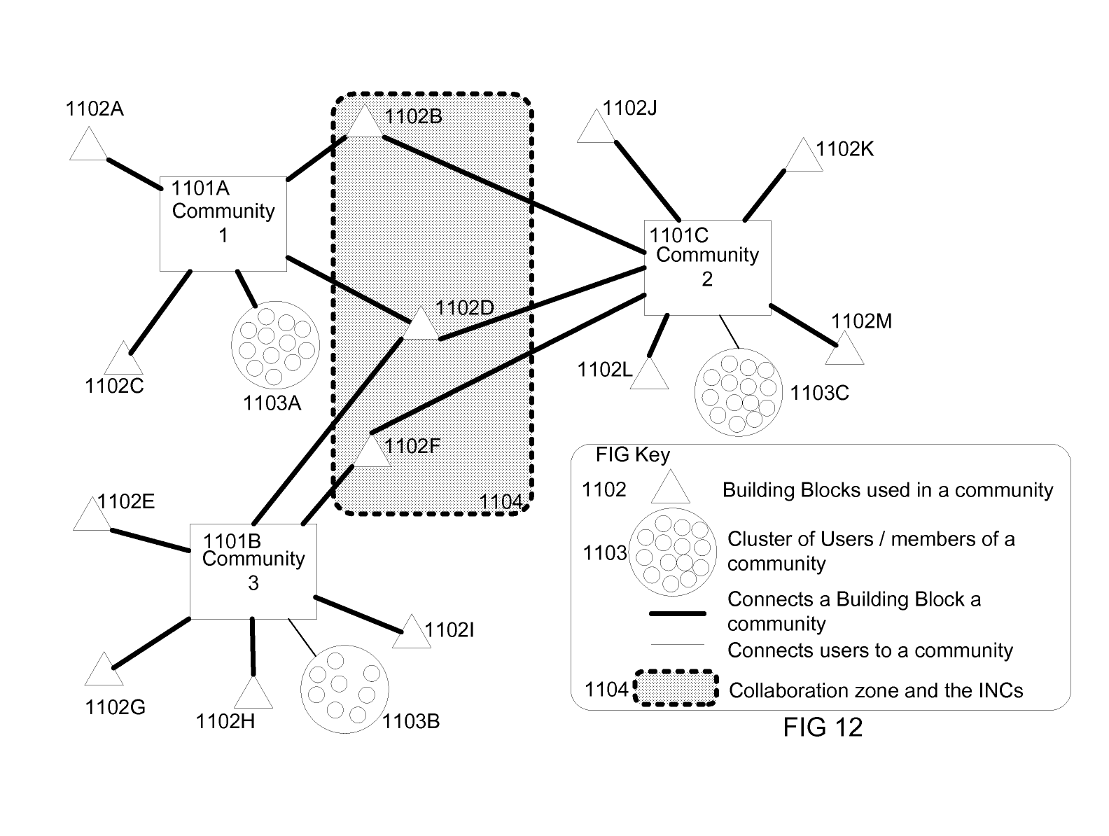

FIG. 12 illustrates an exemplary process model including further details of communities and building blocks that can be based on the embodiments of FIGS. 1-11. In FIG. 12, the communities are linked by virtue of sharing specific know-how building blocks. For examples building block 1102B is shared and thus links Community 1 and 2, building block 1102D is shared and thus links Community 1, 2, and 3, and finally building block 1102F is shared and thus links Community 1 and 3. Advantageously, these communities thus form clusters of Intelligently networked Communities (INCs) for sharing knowledge, collaboration, idea creation, innovations, and more. The users of Community 1, 2, and 3 share same building blocks that are shared by their respective community.

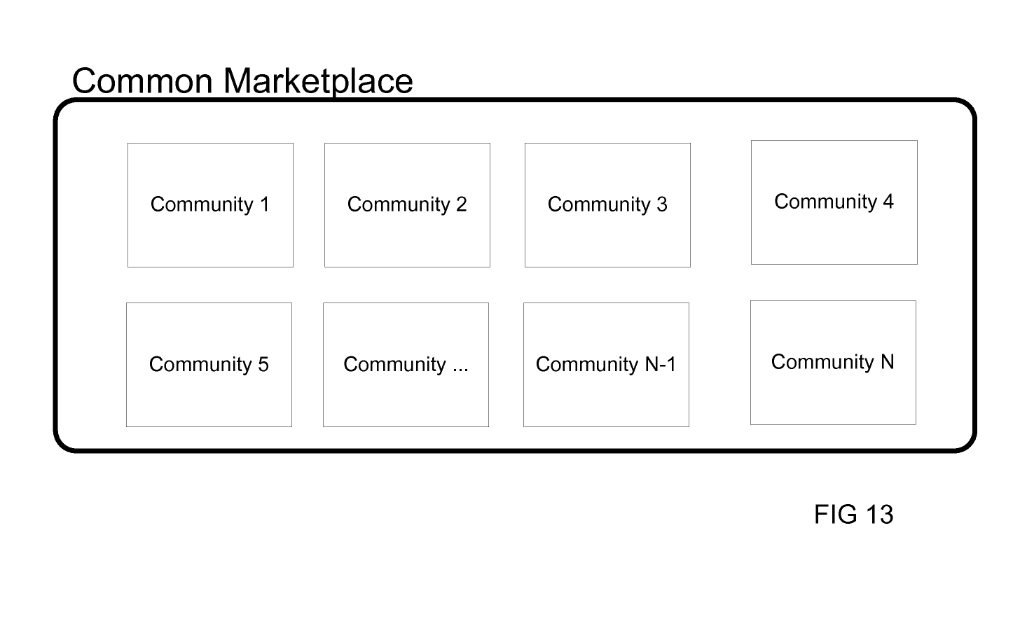

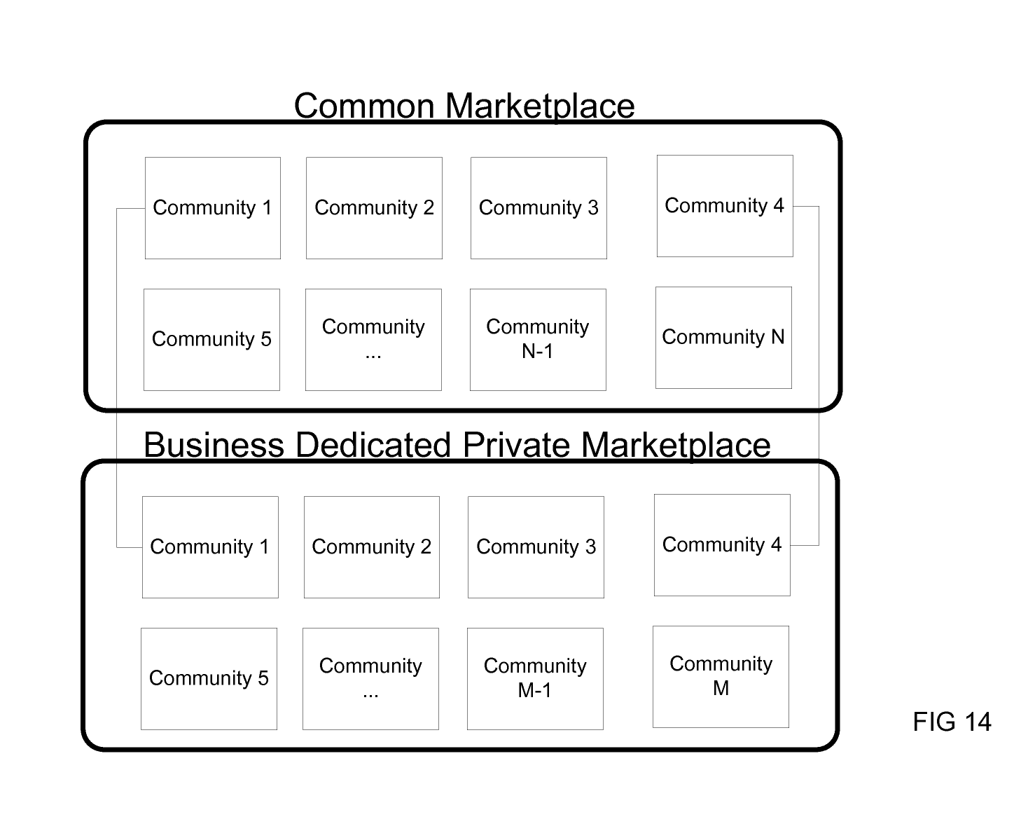

FIG. 13 illustrates an exemplary process model including a common marketplace that can be based on the embodiments of FIGS. 1-12. FIG. 14 illustrates an exemplary process model including common, dedicated and private marketplaces that can be based on the embodiments of FIGS. 1-13. In FIG. 13, communities can exit on both the Common Marketplace, and a Business Dedicated Private Marketplace depicted in FIG. 14. In FIG. 14, a user in pursuit of their business, personal, professional, social, or organizational goals and objectives can create a Business

Dedicated Private Marketplace. The user can create as many independent and linked communities as they want and/or needs. At the same time the user can create as many communities on the Common Marketplace and either link them to those in the private one or keep them independent.

Thus, the present systems and methods connect users based on the opportunities they create and goals they pursue and form Intelligently Networked Communities (INCs) of users working together and helping each other to actualize the opportunities and achieve the goals. The present systems and methods provide a platform to collaborate, communicate, record, and monitor progress of set goals for realization of the opportunities. Users can create knowledge, share experiences, develop their personal brands as subject matter experts and contribute towards building Collective Intelligence of the INCs. The right Opportunities, know-how, collaborators, and goal maps are tailored for a particular user from the collective intelligence of the system and pushed to the user. The present systems and methods are a novel synthesis that integrates different strands of behavioral economics, cognitive science, and modern management practices together with mathematical simulations and semantic technologies, and multiagent systems into a web based resource. The present systems and methods also can be used for providing intelligently networked communities, allowing individuals to create objective and goal focused communities for actualizing the community owner(s)' and/or the community users in pursuit of specific objectives and goals in business, personal, social, professional, organizational, and more. The present systems and methods also can be used for providing the means for individuals to create knowledge building blocks comprising of a Wiki, best practices, common mistakes, and the like, that allow their users to edit, offer changes, expand the know-how for specific applications and use for a global population with diverse demographics and psychographics.

In addition, the knowledge building blocks can be used to create modular context-specific expert content that is multimedia enriched, allowing users to build the repository of their knowledge base as a subject-matter expert, and an effective knowledge management system to access and share knowledge with others. Accordingly, the knowledge building blocks can be used in the intelligently networked communities to make each community unique and at the same time tie many different communities together.

The knowledge building blocks can include subject-specific multimedia content for users to create, promote, and offer their expertise. The knowledge building blocks can be created using tools and techniques available to the users within the system to describe a particular expertise, or the know-how related to specific subjects. The knowledge building blocks can exist and be used in multiple user communities. Thus, the knowledge building blocks can connect members of various communities as well as any independent users together. Advantageously, the knowledge building blocks can be used to create and build a personal Wikipedia of expertise for a user.

In addition, the users can transform their existing digital and printed content (e.g., from web pages, blogs, etc.) into knowledge building blocks, giving rise to a new era of creating and publishing blocks of knowledge content, and the possibility of selling and marketing the knowledge building blocks as modules (e.g., chapter by chapter instead of a whole book, etc.). An analogy to draw from could be the impact of MP3s and iTunes on CDs and music industry. Thus, knowledge building blocks have the potential to do the same to books, printing, publishing, content, and the like.

Accordingly, such use of knowledge building blocks can pave the way to a new era of iChapters and digital publications of expert content that is dynamic, expansive, and updated in real-time by multiple users collaborating together. Advantageously, an age of intelligently networked communities as described herein can be used to pave the way to intelligently networked wisdom, which in turn can pave the way to the creation of the “Intelligent Web.”

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, cloud computing networks, a combination thereof, and the like.

It is to be understood that the described devices and subsystems are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, pigeons, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of illustrative embodiments, and implementations, the present inventions are not so limited, but rather cover various modifications, and equivalent arrangements, which fall within the purview of the appended claims.

1. A computer implemented method for providing intelligently networked communities, the method comprising the steps of:
identifying and selecting suitable potential opportunities for a user via a computer system;
pushing know-how to a user for actualizing an opportunity, including setting targets to achieve a goal via the computer system;
connecting and teaming up a user with other users that complement capabilities and capacities of the user in pursuit of a goal via the computer system; and
generating a goal map for a user to help the user to make decisions and adjust a course when encountering problems along a journey to a goal via the computer system.

2. The method of claim 1, wherein information gathered and received from a plurality of users is provided and made available to other users.

3. The method of claim 1, further comprising establishing connections among users who seek and pursue common goals, irrespective of geographical boundaries, social status, and contacts within a personal network in real life.

4. The method of claim 3, further comprising establishing connections among communities sharing common building blocks and know-how irrespective of the creator of the building block.

5. The method of claim 1, further comprising pushing goal specific know-how that tailored for a user to a user, including steps that a user can take and relevant knowledge and experience available to a user to achieve a particular set goal.

6. The method in claim 5, wherein the goal specific know-how is tailored and pushed to a user, based on recorded knowledge of a user from a past experience of achieving other goals and comparing complimentarity of a user to a plurality of other users.

7. The method of claim 5, further comprising customizing of a goal map for a specific goal that a user pursues, including customizations performed on past experience and knowledge of a user and plurality of other users in pursuing a similar goal.

8. The method of claim 4, further comprising creating modular, context-specific, multimedia enriched, content with the building blocks.

9. The method of claim 4, wherein the building blocks include subject-specific, multimedia content for a user to create, promote, and offer expertise of the user.

10. The method of claim 4, wherein the building blocks are created using system tools and techniques available to a user to describe a particular expertise and/or know-how related to specific subjects.

11. A computer implemented system for providing intelligently networked communities, the system comprising:
a computer system configured for identifying and selecting suitable potential opportunities for a user;
the computer system configured for pushing know-how to a user for actualizing an opportunity, including setting targets to achieve a goal;
the computer system configured for connecting and teaming up a user with other users that complement capabilities and capacities of the user in pursuit of a goal; and
the computer system configured for generating a goal map for a user to help the user to make decisions and adjust a course when encountering problems along a journey to a goal.

12. A computer program product for providing intelligently networked communities including one or more computer readable instructions embedded on a tangible non-transitory computer readable medium and configured to cause one or more computer processors to perform the steps of:
identifying and selecting suitable potential opportunities for a user via a computer system;
pushing know-how to a user for actualizing an opportunity, including setting targets to achieve a goal via the computer system;
connecting and teaming up a user with other users that complement capabilities and capacities of the user in pursuit of a goal via the computer system; and
generating a goal map for a user to help the user to make decisions and adjust a course when encountering problems along a journey to a goal via the computer system.

13. The system of claim 11, wherein information gathered and received from a plurality of users is provided and made available to other users via the computer system.

14. The computer program product of claim 12, wherein information gathered and received from a plurality of users is provided and made available to other users via the computer system.

15. The system of claim 11, further comprising the computer system configured for establishing connections among users who seek and pursue common goals, irrespective of geographical boundaries, social status, and contacts within a personal network in real life.

16. The computer program product of claim 12, further comprising establishing via the computer system connections among users who seek and pursue common goals, irrespective of geographical boundaries, social status, and contacts within a personal network in real life.

17. The system of claim 15, further comprising the computer system configured for establishing connections among communities sharing common building blocks and know-how irrespective of the creator of the building block.

18. The computer program product of claim 16, further comprising establishing via the computer system connections among communities sharing common building blocks and know-how irrespective of the creator of the building block.
